(19) United States
(12) Patent Application Publication
(10) Pub. No.: US 2021/0112648 A1
(43) Pub. Date: Apr. 15, 2021

(54) APPARATUS AND METHOD FOR ACCELERATING CONVERSION OF PHYTOCHROME ISOFORMS

(71) Applicant: Justin NAPIER, Victoria (CA)

(72) Inventor: Justin NAPIER, Victoria (CA)

(21) Appl. No.: 17/066,370

(22) Filed: Oct. 8, 2020

(30) Foreign Application Priority Data
Oct. 15, 2019 (CA) 3058873

(51) Int. Cl. H05B 47/11; A01G 7/04; F21V 31/00; F21S 9/03; H05B 45/22

(52) U.S. Cl. CPC H05B 47/11; A01G 7/045; F21Y 2115/10; F21S 9/032; H05B 45/22; F21V 31/005

(57) ABSTRACT

An apparatus and method for accelerating the conversion of phytochrome far red (Pfr) to phytochrome red (Pr) is provided. It is used for increasing the relative dark period of a plant's diurnal darkness cycle to encourage earlier flowering in short-day flowering plants and longer daylight hours during the flowering phase. The device is a standalone unit which senses the end of the diurnal light cycle and exposes a green plant to a 730±20 nm wavelength of light for a pre-determined period of time using light emitting diodes (LEDs). The device is a self-contained, waterproof unit.

### CROSS REFERENCE TO RELATED APPLICATIONS

This application claims benefit of Canadian Patent Application Serial No. 3,058,873, filed on Oct. 15, 2019, entitled APPARATUS AND METHOD FOR ACCELERATING CONVERSION OF PHYTOCHROME ISOFORMS, the contents of which are incorporated herein by reference.

### FIELD

The present technology is an apparatus that senses the onset of darkness and applies a far-red spectrum of light to accelerate the conversion of phytochrome far red to phytochrome red.

### BACKGROUND

Light Emitting Diodes (LEDs) have created ample opportunities for scientists to study plant hormonal and physiological responses to different spectra. Most of this work has had tremendous commercial potential in the agricultural industry. Reverse engineering of the absorptive spectra of plant species' chloroplast composition has made it possible to create custom recipes of lighting spectra within a single LED-based device. which is superior to conventional lighting not only in power efficiency but more appropriately in photonic efficiency tuned specifically for the target species. This commercial application of LED technology has focused primarily on photosynthetically active radiation (PAR) of wavelengths ranging from 400 nm to 700 nm.

Additional research has been conducted studying non-PAR radiation. This is most often in the ultra-violet (UV) spectrum of 10 nm-400 nm or the near infra-red (NIR) spectrum of 780 nm-2500 nm. While not photosynthetic in nature, these spectra do promote significant physiological and hormonal responses in many plant species. These wavelengths are present in natural light; however, as a result of the filtering of the light through the atmosphere (analogous to light through a prism) the composite spectrum is balanced differently from sunrise to midday and finally at sunset. At sunset for example, the balance of the composite light profile is trending towards longer wavelength spectra such as red to far-red, to infra-red. Plants have evolved to understand this longer wavelength dominant light to signal the onset of night time, wherein an entirely different set of biological functions may take place from the daytime.

In some species of plants, the duration of night is an indicator of the season; as such, the changing length of night-time can trigger a flowering response. It is well known for over 50 years that this process is directed by the ratio of two isoforms of phytochromes. (Vince-Prue, D. and C. G. Guttridge. 1973. Floral initiation in strawberry: Spectral evidence for the regulation of flowering by long-day inhibition. Planta 110:165-172.) Phytochrome far-red (Pfr) and phytochrome red (Pr) are the active and inactive forms, respectively, which absorb photons of the peak spectrum they are named after, which in turn converts them to their opposite form. The ratio of these isoforms is generally understood as the plant's metric for determination of day or night.

As an example, as night approaches the ratio of Pfr:Pr may hypothetically begin as 1.7, but by two hours following nightfall it is reduced to 0.7. Depending on the plant species, this significant change in balance is what then triggers the plant to begin ‘counting’ night-hours. For short-day flowering plants, the overall number of hours of darkness is the trigger to initiate flowering.

Studies have now shown, for example, that by exposing the phytochromes to a dose of far-red light (710 nm-850 nm) at the onset of nightfall it is possible to convert Pfr to Pr much faster than using natural light, and it is therefore possible to trigger flowering in plants with less actual night-hours (Demotes-Mainard S., Pdron T., Corot A., Bertheloot J., Gourrierec J. L., Travier S., Sakr S. (2016) Plant responses to red and far-red lights, applications in horticulture. Environmental and Experimental Botany 121, 4-21.)

U.S. Pat. No. 10,165,735 discloses a dynamically engaged plant stimulation lighting system and methods for growing plants. Specific wavelengths may be provided in the system along with specific color temperature and even specific color rendering index values for optimal plant growth. There is no disclosure to a stand-alone, self-contained lighting system. The limitation of this device is it requires some form of actuation by the user; either manually, through use of a light-timer, or a separately configured control system.

United States Patent Application 20190174682 discloses a plant illumination apparatus that can output light having a high degree of circular polarization in the target wavelength range. This object is achieved by having a reflective-type polarizing plate having an effective wavelength range, a light-emitting device, and a reflective plate configured to reflect light emitted from the light-emitting device and satisfying: .lamda.1>.lamda.2, .lamda.2>.lamda.3, and w>30 nm wherein .lamda.1 is the center wavelength of the effective wavelength range of the reflective-type polarizing plate, .lamda.2 is the center wavelength of the light-emitting device, w is the full width at half maximum of the transmittance of the reflective-type polarizing plate, and .lamda.3 is the shorter wavelength of the wavelengths at the full width at half maximum. This is not a stand-alone, self-contained lighting system. The limitation of this device is it requires some form of actuation by the user; either manually, through use of a light-timer, or a separately configured control system.

United States Patent Application 20180070537 discloses a method and a device to improve growth and production of various crop plants. The plants are exposed to a combination of photosynthetically active light and near infrared light. A rudimentary device is disclosed which consists of strings of lights and a circuit board. The limitation of this device is it requires some form of actuation by the user; either manually, through use of a light-timer, or a separately configured control system.

United States Patent Application 20180007838 discloses that plants are optimally grown under artificial narrowband Photosynthetically Active Radiation (“PAR”) of multiple colors, and color palettes, applied in but partially time-overlapping cycles. As well as a long growing season cycle, the colored lights are cyclically applied on a short diurnal cycle that often roughly simulates a peak-season sunny day at the earth latitude native to the plant. Bluer lights are applied commencing before redder lights and are likewise terminated before the redder lights. Infrared light in particular, is preferably first applied at a time corresponding to early afternoon and is temporally extended past a time corresponding to sunset. The colored lights and light palettes preferably rise to, and fall from, different peak intensities over periods from 10 minutes to 2 hours, and relative peak intensities of even such different colors as are used at all vary up to times two (.times.2) in response to differing PAR requirements of different plants. Computer-controlled colored LED lights realize all. There is no disclosure to a stand-alone, self-contained lighting system. The limitation of this device is it requires some form of actuation by the user; either manually, through use of a light-timer, or a separately configured control system.

United States Patent Application 20170347532 discloses systems for inducing a desired response in an organism by controlling the duty cycle, wavelength band and frequency of photon bursts to an organism, through the photon modulation of one or more photon pulse trains in conjunction with one or more different photon pulse trains to the organism and duty cycle, where the photon modulation and duty cycle is based upon the specific needs of the organism. Devices for inducing a desired response in an organism such as growth, destruction or repair through the photon modulation of one or more photon pulse trains in conjunction with one or more different photon pulse trains to the organism are also provided. Further provided are methods for the optimization of organism growth, destruction or repair through the use of high frequency modulation of photons of individual color spectrums. There is no disclosure to a stand-alone, self-contained lighting system. The limitation of this device is it requires some form of actuation by the user; either manually, through use of a light-timer, or a separately configured control system.

United States Patent Application 20170035002 discloses an apparatus to optimize and enhance plant growth, development and performance at any stage of its development including sowing, growth, flowering, fruit formation or during many processes associated with the handling of the culture through an automated, enclosed and controlled environment system. There is no disclosure to a stand-alone, self-contained lighting system. The limitation of this device is it requires some form of actuation by the user; either manually, through use of a light-timer, or a separately configured control system.

United States Patent Application 20170013786 discloses an improved method to produce artificial light for plant cultivation, an illumination device with a semiconductor light emission solution and device suited for plant cultivation in a greenhouse and/or dark growth chamber environment. The best mode is considered to be a lighting device with LEDs that produces an emission spectrum similar to the photosynthetically active radiation (PAR) spectrum in a dark growth chamber. The methods and arrangements allow more precise spectral tuning of the emission spectrum for lights used in plant (310, 311) cultivation. Therefore, unexpected improvements in the photomorphogenetic control of plant growth, and further improvements in plant production, especially in dark growth chambers, such as basements, are realized. There is no disclosure to a stand-alone, self-contained lighting system. The limitation of this device is it requires some form of actuation by the user; either manually, through use of a light-timer, or a separately configured control system.

United States Patent Application 20120218750 discloses systems and methods for promoting plant growth that combine beam angle control with spectral control. In one embodiment, an optical device can be configured to emit multiple colors of light at particular wavelengths. The optical device may also be configured to generate an emission spectrum with multiple peaks. The spectrum can be selected based on stimulating biological processes of a plant. There is no disclosure to a stand-alone, self-contained lighting system. The limitation of this device is it requires some form of actuation by the user; either manually, through use of a light-timer, or a separately configured control system.

There are examples of LED lighting systems which may add a far-red spectrum to the end-of-day before the lights are turned off for the night; however, these are complex and multi-spectral arrays of LEDs and not modular in the sense that they are not appropriate for all types of plants' spectral requirements. Additionally, they include many other complex, high-powered LED arrays which may not be a desired feature of the lighting program. The limitation with these devices is they require some form of actuation by the user; either manually, through use of a light-timer, or a separately configured and complex control system.

There also exist examples of supplemental far-red lighting which are available from several horticultural LED manufacturers. The limitation with these devices is they require some form of actuation by the user; either manually, through use of a light-timer, or a separately configured and complex control system.

What is needed is an apparatus with a dynamic light-sensing apparatus to control the biological functions of a plant's photoperiodic hormonal rhythms. It would be preferable if the apparatus was autonomous. It would also be preferable if it delivered a specific wavelength of light of 730 nm 20 nm. It would be further preferable if it was portable, was self-contained and was waterproof.

### SUMMARY

The present technology provides an apparatus with a dynamic light-sensing apparatus to control the biological functions of a plant's photoperiodic hormonal rhythms. The apparatus is autonomous. The apparatus delivers a specific wavelength of 730 nm (±20 nm) to plant or algal tissue. It is portable, self-contained and waterproof. A sensor is used to detect the onset of darkness. When this condition is detected, an array of one or more 730±20 nm peak wavelength LEDs are energized for a duration of time of about an hour. Batteries may be used to energize the system. Solar cells may be used to charge the batteries. Either solid-state electronics or a microprocessor may be used to govern the system logic.

In one embodiment, an autonomous apparatus for use with a power source is provided, for emitting far-red light in response to a pre-determined light threshold level, the autonomous apparatus comprising a far-red light transmitting housing, and housed in the far-red light transmitting housing: a microprocessor; at least one light sensor which is electronic communication with the microprocessor; and at least one far-red light emitting diode (LED) light source, which is in electronic communication with the microprocessor, wherein the microprocessor is configured to track signals from the light sensor and in response to decreasing light levels, switch on at least one far-red LED light source at the pre-determined light threshold level and switch off the at least one far-red LED light source after an “on” pre-determined length of time.

In autonomous apparatus, the microprocessor may be further configured to maintain at least one far-red LED light source in an off mode for an “off” pre-determined length of time.

In autonomous apparatus, the far-red light transmitting housing may be waterproof.

In autonomous apparatus, the far-red light transmitting housing may be a cylinder with end caps.

The autonomous apparatus may further comprise a battery as the power source, which is in electrical communication with the microprocessor and the at least one far-red LED light source.

In autonomous apparatus, the battery may be housed in the far-red light transmitting housing.

The autonomous apparatus may further comprise at least one solar cell, which is in electrical communication with the battery and is housed in the far-red light transmitting housing.

In autonomous apparatus, the “off” pre-determined time may be between about 20 hours to about 24 hours.

In autonomous apparatus, the “on” pre-determined time may be between about 1 minute and about 1 hour.

In autonomous apparatus, at least one far-red LED may emit specifically at 730±20 nm.

In another embodiment, a method of accelerating the conversion of phytochrome far-red (Pfr) and phytochrome red (Pr) in a green plant is provided, the method comprising: selecting an apparatus that autonomously senses decreasing light intensity and emits far-red light for a pre-selected amount of time in response to the light intensity reaching a threshold; and placing the apparatus proximate the green plant to provide a photon flux density of at least about 2 μmol·s⁻¹·m⁻².

In yet another embodiment, a method of accelerating the conversion of phytochrome far-red (Pfr) and phytochrome red (Pr) in a green plant is provided, the method comprising: selecting the autonomous apparatus described above; and placing the autonomous apparatus proximate the green plant to provide a photon flux density of at least about 2 μmol·s⁻¹·m⁻².

### BRIEF DESCRIPTION OF THE DRAWINGS

FIG. 1 is a schematic of the present technology.

FIG. 2 is a schematic of an alternative embodiment of the present technology.

FIG. 3 is a schematic of an alternative embodiment of the present technology.

FIG. 4 is a block diagram showing the logic of the apparatus of FIG. 1.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### Definitions

Far-red LED—in the context of the present technology, a far-red LED only emits light that has a wavelength of 730±20 nm.

Far-red light transmitting—in the context of the present technology, a substrate that is far-red transmitting allows for substantially all the light with a wavelength of 730±20 nm to pass through.

Green plant—in the context of the present technology, a green plant is any photosynthetic plant ranging from unicellular to multicellular and including, but not limited to algae, flowering plants, deciduous trees and coniferous trees.

### DETAILED DESCRIPTION

In a geographic location where the local flowering season is shorter than the native flowering season of a target plant species, it may be challenging for a short-day flowering plant to mature before the growing season ends. This may be because of the late onset of long nights and shorter growing season due to lack of sufficient sunlight, rain, or low temperatures. A simple, standalone, autonomous apparatus to accelerate the conversion of phytochromes at the onset of the night cycle to trigger flowering earlier in the season would be effective for extending the range and potential of a species of short-day flowering plants to exist in geographic locations previously considered less appropriate for raising such species.

Alternatively, in controlled lighting conditions where artificial light is the primary source of PAR, an apparatus which accelerates conversion of the Pfr isoform to Pr at the onset of the night cycle would allow the plants to receive more daylight hours in lieu of the night-hours by inducing rapid phytochrome conversion. For example, a conventional photoperiod may use a 12-12 hours lights on to lights off cycle in flowering. Using this apparatus and method it may be possible to extend the hours on into the hours off portion of the photoperiod to, for example, 14-10 hours lights on to lights off. The potential advantages of this method could result in shorter flowering periods and larger yields.

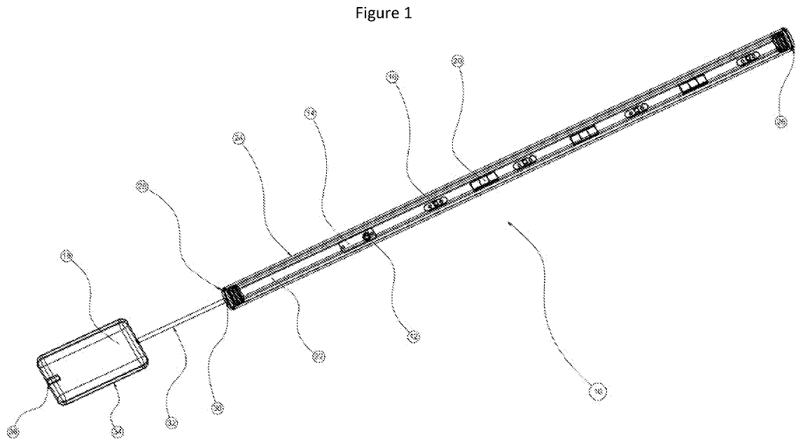

As shown in FIG. 1, the apparatus, generally referred to as 10, is a wand that includes one or more light sensors 12 which are in electronic communication with a microprocessor 14. The microprocessor 14, in turn, is in electronic communication with one or more far-red LEDs 16 (wavelength of light of 730 nm+20 nm). A battery 18 is in electrical communication with both the microprocessor 14 and the far-red emitting LEDs 16. The battery 18 is also in electrical communication with one or more solar cells 20. The light sensors 12, the microprocessor 14, the one or more far-red LEDs 16 and the solar cells 20, are all housed within a bore 22 of the wand 10. In one embodiment, the battery 18 may be integrated into the wand 10. The wand 10 includes a far-red light transmitting housing 24, which may be, for example, but not limited to a plastic polymeric material or glass. In this embodiment, it is a round tube. A first end cap 26 seals the first end of the clear housing 24. A second end cap 28 is provided with an aperture 30 through which an electrical connection 32 extends, thus connecting the battery 18 with the light sensor 12, the microprocessor 14, the far-red LED or far-red LEDs 16 and the solar cell 20 or solar cells 20. The second end cap 28 seals the second end of the clear housing 24, thus the wand 10 is waterproof.

In one embodiment, the light sensor 12 is a photoresistor. In another embodiment, the light sensor 12 is a photocell. In another embodiment, the light sensor 12 is a solar cell. In all embodiments, the battery 18, if not integrated into the wand 10, is housed in a waterproof housing 34 which includes a Universal Serial Bus (USB) port 36.

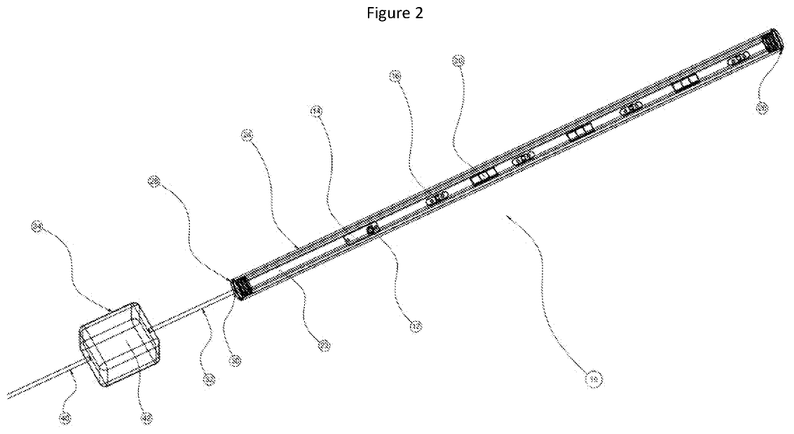

In another embodiment, shown in FIG. 2, power is provided by AC power, via a power cord 40 which is in electrical communication with a DC converter 42, which in turn is in electrical communication with the light sensor 12, the microprocessor 14 and the far-red LED or far-red LEDs 16. The DC converter 42 is housed in a waterproof case 34.

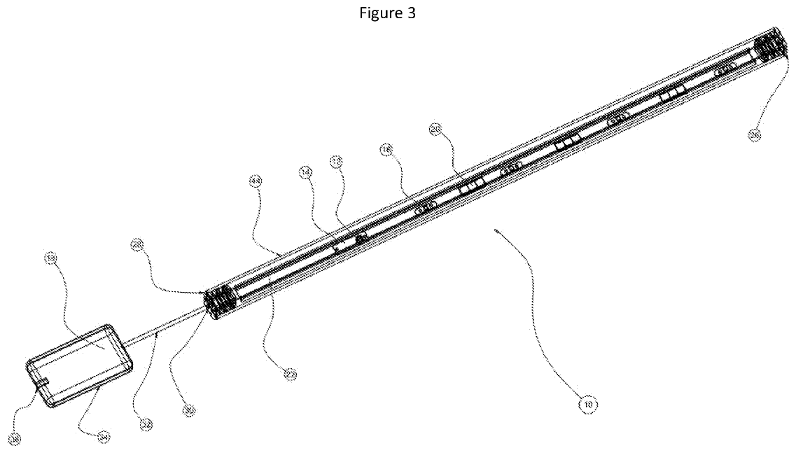

As shown in FIG. 3, in an alternative embodiment, the apparatus, generally referred to as 10, is a wand that includes one or more light sensors 12 which are in electronic communication with a microprocessor 14. The microprocessor 14, in turn, is in electronic communication with one or more far-red LEDs 16 (wavelength of light of 730 nm+20 nm). A battery 18 is in electrical communication with both the microprocessor 14 and the far-red emitting LEDs 16. The battery 18 is also in electrical communication with one or more solar cells 20. The light sensors 12, the microprocessor 14, the one or more far-red LEDs 16 and the solar cells 20, are all housed within a bore 22 of the wand 10. In one embodiment, the battery 18 may be integrated into the wand 10. The wand 10 includes a far-red light transmitting housing 44, which may be, for example, but not limited to a plastic polymeric material or glass. In this embodiment, it is a rectangular tube. A first end cap 26 seals the first end of the clear housing 24. A second end cap 28 is provided with an aperture 30 through which an electrical connection 32 extends, thus connecting the battery 18 with the light sensor 12, the microprocessor 14, the far-red LED or far-red LEDs 16 and the solar cell 20 or solar cells 20. The second end cap 28 seals the second end of the clear housing 24, thus the wand 10 is waterproof.

The apparatus 10 is a standalone device for sensing ambient light levels and energizing a far-red LED 16 array of one or more lights for a duration of between 1 and 60 minutes. The apparatus 10 is to be installed in a horticultural setting, within a sufficient proximity to the target plant(s) to achieve a photon flux density of at least about 2 μmol·s⁻¹·m⁻².

In one embodiment, the wand 10 may be mounted on a post or hung from above. In another embodiment, the wand may be mounted directly on the plant. The far-red LEDs 16 are directed towards the plant(s). The wand 10 is waterproof and may be installed outdoors, in a greenhouse, or in an artificial growing chamber without compromising the integrity of the device due to humidity.

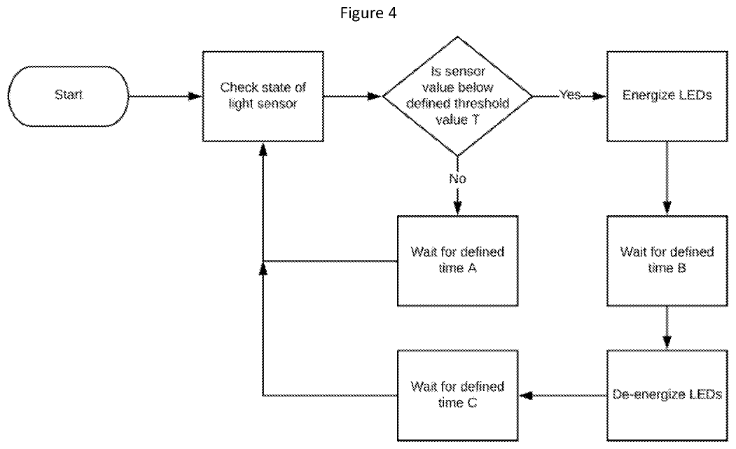

The logic for the system is shown in FIG. 4. The functions are carried out by a microprocessor 14. The values of the pre-determined light threshold (T) and the defined times (A, B, and C) are either fixed or user-adjustable. The light sensors 12 detect increasing and decreasing light levels. As the light level decreases, the microprocessor tracks the decrease and at the pre-determined light threshold level, which is determined by the microprocessor 14, the microprocessor 14 triggers the energizing of the far-red LEDs 16. After a pre-determined period of time (which may be fixed or may be user-defined) the microprocessor triggers the de-energizing of the far-red LEDs. After the on-cycle, the microcontroller allows a defined period of time (which may be fixed or may be user-defined) of between 20 and 24 hours before it repeats the process from the beginning.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. For example, the housing can be a range of shapes and sizes, for example, the housing could be square and a plurality of apparatuses would be employed. Such equivalents are intended to be encompassed in the scope of the claims, if appended hereto or subsequently filed.

1. An autonomous apparatus for use with a power source, for emitting far-red light in response to a pre-determined light threshold level, the autonomous apparatus comprising a far-red light transmitting housing, and housed in the far-red light transmitting housing: a microprocessor; at least one light sensor which is electronic communication with the microprocessor; and at least one far-red light emitting diode (LED) light source, which is in electronic communication with the microprocessor, wherein the microprocessor is configured to track signals from the light sensor and in response to decreasing light levels, switch on at least one far-red LED light source at the pre-determined light threshold level and switch off the at least one far-red LED light source after an “on” pre-determined length of time.

2. The autonomous apparatus of claim 1, wherein the microprocessor is further configured to maintain at least one far-red LED light source in an off mode for an “off” pre-determined length of time.

3. The autonomous apparatus of claim 2, wherein the far-red light transmitting housing is waterproof.

4. The autonomous apparatus of claim 3, wherein the far-red light transmitting housing is a cylinder with end caps.

5. The autonomous apparatus of claim 4, further comprising a battery as the power source, which is in electrical communication with the microprocessor and the at least one far-red LED light source.

6. The autonomous apparatus of claim 5, wherein the battery is housed in the far-red light transmitting housing.

7. The autonomous apparatus of claim 6, further comprising at least one solar cell, which is in electrical communication with the battery and is housed in the far-red light transmitting housing.

8. The autonomous apparatus of claim 7, wherein the “off” pre-determined time is between about 20 hours to about 24 hours.

9. The autonomous apparatus of claim 8, wherein the “on” pre-determined time is between about 1 minute and about 1 hour.

10. The autonomous apparatus of claim 10, wherein at least one far-red LED emits specifically at 730±20 nm.

11. A method of accelerating the conversion of phytochrome far-red (Pfr) and phytochrome red (Pr) in a green plant, the method comprising: selecting an apparatus that autonomously senses decreasing light intensity and emits far-red light for a pre-selected amount of time in response to the light intensity reaching a threshold; and placing the apparatus proximate the green plant to provide a photon flux density of at least about 2 μmol·s⁻¹·m⁻².

12. A method of accelerating the conversion of phytochrome far-red (Pfr) and phytochrome red (Pr) in a green plant, the method comprising: selecting the autonomous apparatus of claim 1; and placing the autonomous apparatus proximate the green plant to provide a photon flux density of at least about 2 μmol·s⁻¹·m⁻².
